(19) United States
(12) Patent Application Publication
(10) Pub. No.: US 2018/0146530 A1
(43) Pub. Date: May 24, 2018

(54) SAFETY LAMP

(71) Applicant: ProLight Opto Technology Corporation, Taoyuan City (TW)

(72) Inventors: Chen-Lun HSING CHEN, Taoyuan City (TW); Yiwen TANG, Taoyuan City (TW)

(21) Appl. No.: 15/609,415

(22) Filed: May 31, 2017

(30) Foreign Application Priority Data
Nov. 18, 2016 (TW) 105217623

(51) Int. Cl. H05B 37/02

(52) U.S. Cl. CPC H05B 37/0218; H05B 37/0227; H05B 37/0281

(57) ABSTRACT

A safety lamp includes a light sensing unit, a first driving unit, a motion sensing unit, a second driving unit, a time setting unit, and a light-emitting unit. The first driving unit outputs a low-current power and the second driving unit outputs a high-current power. The motion sensing unit senses a movement of an object and output a sensing signal. The time setting unit counts the number of lighting times of the light-emitting unit. The light-emitting unit is driven by the low-current power when the light sensing unit is turned on; the light-emitting unit is driven by the low-current power and the high-current power when the motion sensing unit is turned on; when the number of lighting times is completed, the time setting unit disconnects the high-current power outputted from the second driving unit to the light emitting unit.

### BACKGROUND

### Technical Field

The present invention relates to a safety lamp, and more particularly to a safety lamp with an automatic turn-on function.

### Description of Related Art

The safety lamp installed at the home entrance or the home vestibule usually provides a motion sensor to sense a movement of an object. In general, the motion sensor produces a sensing signal and the sensing signal is transmitted to an external control device to lighten the safety lamp so as to provide illuminations and further synchronously control a surveillance camera for the security protection of family members. In addition, when a person walks through the home vestibule in the dark, the motion sensor senses the movement of the person to automatically lighten the safety lamp so as to prevent the person from falling or injuring.

The conventional control circuit of the safety lamp manly includes a light sensor, a motion sensor, a central processing unit (CPU), and a light emitting unit. In the operation of the safety lamp, the light sensor is used to sense the ambient light. When the ambient light is insufficient, the light sensor outputs a light sensing signal to the CPU, and the CPU is used to output a PWM (pulse width modulation) signal with a 10% duty cycle to drive the light emitting unit in soft illumination. When the motion sensor senses a movement of an object, the motion sensor outputs a motion sensing signal to the CPU, and the CPU is used to output the PWM signal with a 90% duty cycle to drive the light emitting unit in accent illumination, thereby being used for lighting.

However, the safety lamp is controlled by the PWM signal with two different duty cycles outputted from the CPU to drive the light emitting unit in different illuminations. The conventional safety lamp needs to be controlled by more electronic components of the CPU, thereby complicating designs and increasing production costs of the circuits.

### SUMMARY

An objective of the present invention is to provide a safety lamp to solve existing disadvantage. The safety lamp provides a circuit topology of a single power or a circuit topology of a dual power to drive a light emitting unit in soft illumination, in accent illumination, or in full illumination. Accordingly, a simple control circuit of the safety lamp is implemented to save electricity, reduce costs, and be good used for lighting.

In order to achieve the above-mentioned objective, the safety lamp is connected to a light-emitting unit. The safety lamp includes a light sensing unit, a first driving unit, a motion sensing unit, a second driving unit, and a time setting unit. The light sensing unit senses ambient light. The first driving unit is electrically connected to the light sensing unit, and the first driving unit receives a first signal outputted from the light sensing unit to output a low-current power. The motion sensing unit is electrically connected to the light sensing unit, and the motion sensing unit senses a movement of an object to output a sensing signal. The second driving unit is electrically connected to the motion sensing unit, and the second driving unit receives a second signal outputted from the motion sensing unit to output a high-current power. The time setting unit is electrically connected to the second driving unit, and the time setting unit counts the number of lighting times of the light-emitting unit. The light-emitting unit is driven by the low-current power when the light sensing unit is turned on. The light-emitting unit is driven by the low-current power and the high-current power when the motion sensing unit is turned on. When the number of lighting times is completed, the time setting unit disconnects the high-current power outputted from the second driving unit to the light emitting unit.

In one embodiment, the light sensing unit is a photodiode or a photoresistor.

In one embodiment, the first driving unit includes at least one resistor with a high resistance value so that the low-current power is outputted through the at least one resistor with the high resistance value of the first driving unit.

In one embodiment, the motion sensing unit is a passive infrared motion sensor.

In one embodiment, the second driving unit comprises at least one resistor with a low resistance value so that the high-current power is outputted through the at least one resistor with the low resistance value of the second driving unit.

In one embodiment, the time setting unit is a time limit relay.

In one embodiment, the safety lamp further includes a power supply unit. The power supply unit is electrically connected to the light sensing unit, and the power supply unit supplies the required power to the safety lamp.

In order to achieve the above-mentioned objective, the safety lamp is connected to a light-emitting unit. The safety lamp includes a light sensing unit, a driving unit, a power sharing circuit, a motion sensing unit, and a time setting unit. The light sensing unit senses ambient light. The driving unit is electrically connected to the light sensing unit, and the driving unit outputs a power. The power sharing circuit is electrically connected to the driving unit, and the power sharing circuit includes a first resistor element and a second resistor element connected in parallel to the first resistor element. The motion sensing unit is electrically connected between the driving unit and the second resistor element, and the motion sensing unit senses a movement of an object to output a sensing signal. The time setting unit is electrically connected between the motion sensing unit and the second resistor element, and the time setting unit counts the number of lighting times of the light-emitting unit. The light-emitting unit is driven by the power delivered to the first resistor element when the light sensing unit is turned on. The light-emitting unit is driven by the power boosted according to a less equivalent resistance value of the in-parallel first resistor element and second resistor element when the motion sensing unit and the time setting unit are turned on. When the number of lighting times is completed, the time setting unit is turned off and the light emitting unit is driven by the power delivered through the first resistor element.

In one embodiment, the light sensing unit is a photodiode or a photoresistor.

In one embodiment, the motion sensing unit is a passive infrared motion sensor.

In one embodiment, the first resistor element and the second resistor element are resistor elements with high resistance values.

In one embodiment, the time setting unit is a time limit relay.

In one embodiment, the safety lamp further includes a power supply unit. The power supply unit is electrically connected to the light sensing unit, and the power supply unit supplies the required power to the safety lamp.

It is to be understood that both the foregoing general description and the following detailed description are exemplary, and are intended to provide further explanation of the present invention as claimed. Other advantages and features of the present invention will be apparent from the following description, drawings and claims.

### BRIEF DESCRIPTION OF DRAWING

The present invention can be more fully understood by reading the following detailed description of the embodiment, with reference made to the accompanying drawings as follows:

FIG. 1 shows a schematic circuit block diagram of a safety lamp according to a first embodiment of the present invention.

FIG. 2 shows a schematic circuit block diagram of the safety lamp according to a second embodiment of the present invention.

### DETAILED DESCRIPTION

Reference will now be made to the drawing figures to describe the present invention in detail. It will be understood that the drawing figures and exemplified embodiments of present invention are not limited to the details thereof.

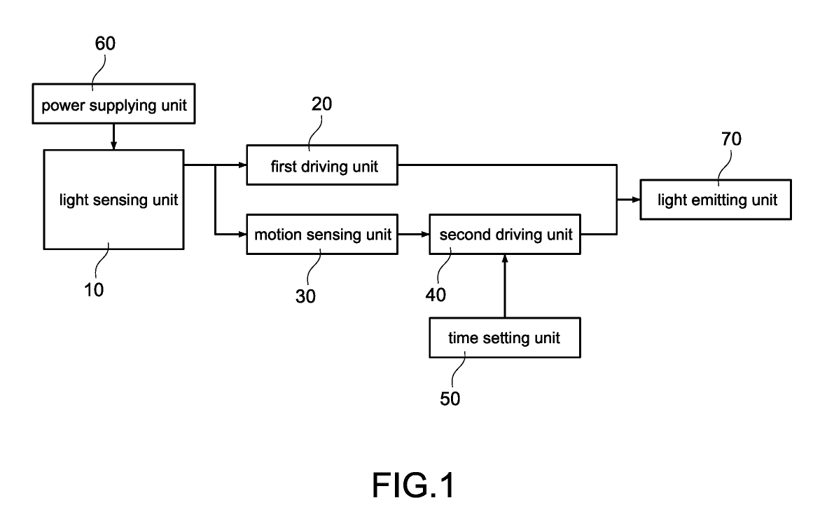

Refer to FIG. 1, which shows a schematic circuit block diagram of a safety lamp according to a first embodiment of the present invention. The safety lamp includes a light sensing unit 10, a first driving unit 20, a motion sensing unit 30, a second driving unit 40, a time setting unit 50, a power supplying unit 60, and a light emitting unit 70. The light sensing unit 10 and the motion sensing unit 30 are used to sense movements of environmental conditions and objects so as to output different power sources to drive the light emitting unit 70 in different illuminations. The light sensing unit 10 senses ambient light and then outputs a signal, such as a power signal. In this embodiment, the light sensing unit 10 is a photo diode or a photoresistor.

The first driving unit 20 is electrically connected to the light sensing unit 10, and the first driving unit 20 has a resistor (not shown) with a high resistance value (hereinafter referred to as “high-value resistor” so that a low-current power (or a low-power signal) is outputted through the high-value resistor of the first driving unit 20. The low-current power outputted from the first driving unit 20 is used to drive the light emitting unit 70 in soft illumination. In this embodiment, the low-current power is 5% of a total output power.

The motion sensing unit 30 is electrically connected to the light sensing unit 10. The motion sensing unit 30 receives a signal outputted from the light sensing unit 10 to sense the movement of the object. In this embodiment, the motion sensing unit 30 is a PIR motion sensor (passive infrared motion sensor).

The second driving unit 40 is electrically connected to the motion sensing unit 30, and the second driving unit 40 has a resistor (not shown) with a low resistance value (hereinafter referred to as “low-value resistor” so that a high-current power (or a high-power signal) is outputted through the low-value resistor of the second driving unit 40. The high-current power outputted from the second driving unit 40 is used to drive the light emitting unit 70 in accent illumination, thereby being used for lighting. In this embodiment, the high-current power is 95% of the total output power.

The time setting unit 50 is electrically connected to the second driving unit 40, and the time setting unit 50 is used to control illumination time of the light emitting unit 70 driven by the second driving unit 40. In this embodiment, the time setting unit 50 is a time-limit relay.

The power supplying unit 60 is electrically connected to the light sensing unit 10, and the power supplying unit 60 is used to supply the required power to the safety lamp. In this embodiment, the power supplying unit 60 supplies an AC (alternating current) power source or a DC (direct current) power source.

The light emitting unit 70 is electrically connected to the first driving unit 20 and the second driving unit 40, and the light emitting unit 70 is driven to produce illumination by one or both of the first driving unit 20 and the second driving unit 40. In this embodiment, the light emitting unit 70 is a light-emitting diode or a lamp bulb.

In the operation of the safety lamp, the power supplying unit 60 is used to supply the required power to the safety lamp. When the light sensing unit 10 senses that the ambient light is insufficient, the light sensing unit 10 is turned on so that the power supplied by the power supplying unit 60 is delivered to the first driving unit 20 through the light sensing unit 10. Accordingly, the low-current power outputted from the first driving unit 20 with the high-value resistor drives the light emitting unit 70 in soft illumination, thereby saving electricity of the light emitting unit 70 of the safety lamp.

When the motion sensing unit 30 senses that an object is in a sensing zone, the motion sensing unit 30 is turned on so that the power supplied by the power supplying unit 60 is delivered to the second driving unit 40 through the light sensing unit 10 and the motion sensing unit 30. Accordingly, the high-current power outputted from the second driving unit 40 with the low-value resistor and the low-current power outputted from the first driving unit 20 with the high-value resistor simultaneously drive the light emitting unit 70 in full illumination, thereby being good used for lighting.

When the light emitting unit 70 is lightened, the time setting unit 50 is triggered to count the number of lighting times. For example, when the number of lighting times, such as 10 or 20 seconds is completed, the time setting unit 50 is used to disable the second driving unit 40, thereby disconnecting the high-current power outputted from the second driving unit 40 to the light emitting unit 70. At this time, the light emitting unit 70 is lightened in soft illumination by only the first driving unit 20.

Accordingly, a simple control circuit of the safety lamp is implemented to save electricity, reduce costs, and be good used for lighting.

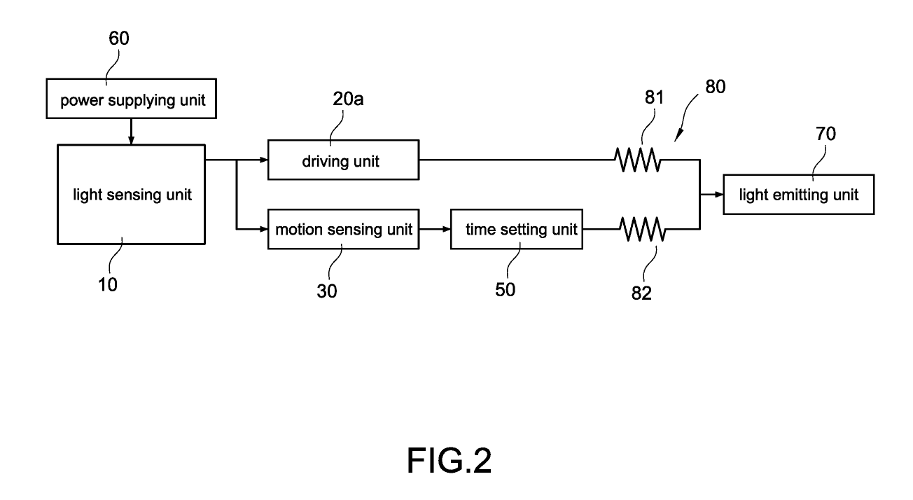

Refer to FIG. 2, which shows a schematic circuit block diagram of the safety lamp according to a second embodiment of the present invention. The embodiment shown in FIG. 2 is nearly identical to the embodiment shown in FIG. 1. The difference between the two embodiments is that the light sensing unit 10 in the embodiment shown in FIG. 2 is electrically to a driving unit 20a, and the driving unit 20a is further electrically connected to a power sharing circuit 80. The power sharing circuit 80 includes a first resistor element 81 and a second resistor element 82 connected in parallel to the first resistor element 81. In addition, a motion sensing unit 30 and a time setting unit 50 are electrically connected in series between the second resistor element 82 and the driving unit 20a. The power sharing circuit 80 is further electrically connected to a light emitting unit 70. In this embodiment, the first resistor element 81 and the second resistor element 82 are resistor elements with high resistance values.

In the operation of the safety lamp, the power supplying unit 60 is used to supply the required power to the safety lamp. When the light sensing unit 10 senses that the ambient light is insufficient, the light sensing unit 10 is turned on so that the power supplied by the power supplying unit 60 is delivered to the driving unit 20a through the light sensing unit 10. At this time, the motion sensing unit 30 is turned off. Accordingly, a low-current power outputted from the driving unit 20a is delivered to the first resistor element 81 of the power sharing circuit 80 to drive the light emitting unit 70 in soft illumination, thereby saving electricity of the light emitting unit 70 of the safety lamp.

When the motion sensing unit 30 senses that an object moves, the motion sensing unit 30 and the time setting unit 50 are turned on so that the power supplied by the power supplying unit 60 is delivered to the second driving unit 40 through the light sensing unit 10 and the motion sensing unit 30. At this time, the first resistor element 81 and the second resistor element 82 are connected in parallel to provide an equivalent resistance value which is less than any one of the first resistor element 81 and the second resistor element 82. In particular, when a resistance value of the first resistor element 81 is equal to that of the second resistor element 82, the equivalent resistance value is equal to one half of the resistance value of the first resistor element 81 or that of the second resistor element 82. Accordingly, the power outputted from the driving unit 20a is boosted by the power sharing circuit 80 to drive the light emitting unit 70 in full illumination, thereby being good used for lighting.

When the light emitting unit 70 is lightened, the time setting unit 50 is triggered to count the number of lighting times. For example, when the number of lighting times, such as 10 or 20 seconds is completed, the time setting unit 50 is used to disconnect a current flowing from the second resistor element 82 to the light emitting unit 70. At this time, the light emitting unit 70 is lightened in soft illumination by only the driving unit 20a.

Although the present invention has been described with reference to the preferred embodiment thereof, it will be understood that the present invention is not limited to the details thereof. Various substitutions and modifications have been suggested in the foregoing description, and others will occur to those of ordinary skill in the art. Therefore, all such substitutions and modifications are intended to be embraced within the scope of the present invention as defined in the appended claims.

What is claimed is:

1. A safety lamp connected to a light-emitting unit, the safety lamp comprising:
a light sensing unit configured to sense ambient light;
a first driving unit electrically connected to the light sensing unit, and the first driving unit configured to receive a first signal outputted from the light sensing unit to output a low-current power;
a motion sensing unit electrically connected to the light sensing unit, and the motion sensing unit configured to sense a movement of an object to output a sensing signal;
a second driving unit electrically connected to the motion sensing unit, and the second driving unit configured to receive a second signal outputted from the motion sensing unit to output a high-current power; and
a time setting unit electrically connected to the second driving unit, and the time setting unit configured to count the number of lighting times of the light-emitting unit;
wherein the light-emitting unit is driven by the low-current power when the light sensing unit is turned on; the light-emitting unit is driven by the low-current power and the high-current power when the motion sensing unit is turned on; when the number of lighting times is completed, the time setting unit is configured to disconnect the high-current power outputted from the second driving unit to the light emitting unit.

2. The safety lamp in claim 1, wherein the light sensing unit is a photodiode or a photoresistor.

3. The safety lamp in claim 1, wherein the first driving unit comprises at least one resistor with a high resistance value so that the low-current power is outputted through the at least one resistor with the high resistance value of the first driving unit.

4. The safety lamp in claim 1, wherein the motion sensing unit is a passive infrared motion sensor.

5. The safety lamp in claim 1, wherein the second driving unit comprises at least one resistor with a low resistance value so that the high-current power is outputted through the at least one resistor with the low resistance value of the second driving unit.

6. The safety lamp in claim 1, wherein the time setting unit is a time limit relay.

7. The safety lamp in claim 1, further comprises:
a power supply unit electrically connected to the light sensing unit, and the power supply unit configured to supply the required power to the safety lamp.

8. A safety lamp connected to a light-emitting unit, the safety lamp comprising:
a light sensing unit configured to sense ambient light;
a driving unit electrically connected to the light sensing unit, and the driving unit configured to output a power;
a power sharing circuit electrically connected to the driving unit, and the power sharing circuit comprising a first resistor element and a second resistor element connected in parallel to the first resistor element;
a motion sensing unit electrically connected between the driving unit and the second resistor element, and the motion sensing unit configured to sense a movement of an object to output a sensing signal; and
a time setting unit electrically connected between the motion sensing unit and the second resistor element, and the time setting unit configured to count the number of lighting times of the light-emitting unit;
wherein the light-emitting unit is driven by the power delivered to the first resistor element when the light sensing unit is turned on; the light-emitting unit is driven by the power boosted according to a less equivalent resistance value of the in-parallel first resistor element and second resistor element when the motion sensing unit and the time setting unit are turned on; when the number of lighting times is completed, the time setting unit is turned off and the light emitting unit is driven by the power delivered through the first resistor element.

9. The safety lamp in claim 8, wherein the light sensing unit is a photodiode or a photoresistor.

10. The safety lamp in claim 8, wherein the motion sensing unit is a passive infrared motion sensor.

11. The safety lamp in claim 8, wherein the first resistor element and the second resistor element are resistor elements with high resistance values.

12. The safety lamp in claim 8, wherein the time setting unit is a time limit relay.

13. The safety lamp in claim 8, further comprises:
a power supply unit electrically connected to the light sensing unit, and the power supply unit configured to supply the required power to the safety lamp.
